(19) United States
(12) Patent Application Publication
(10) Pub. No.: US 2025/0025938 A1
(43) Pub. Date: Jan. 23, 2025

(54) COLD ISOSTATIC PRESSING APPARATUS

(71) Applicant: Joseph Byrne Franklin, Blackpool (GB)

(72) Inventor: Joseph Byrne Franklin, Blackpool (GB)

(73) Assignee: Precision Elements Ltd, Blackpool (GB)

(21) Appl. No.: 18/222,496

(22) Filed: Jul. 17, 2023

(51) Int. Cl. B22F 3/04; B28B 3/00; B29C 43/00; B29C 43/10; B29C 43/36

(52) U.S. Cl. CPC B22F 3/04; B28B 3/003; B29C 43/006; B29C 43/102; B29C 43/3607

(57) ABSTRACT

The present disclosure discloses a cold isostatic pressing apparatus. The apparatus comprises a container having a cavity to hold a pressure medium. The cavity comprises one or more openings. The openings comprise a first opening and a second opening. The cavity is configured to receive at least one sample through the first opening. The apparatus further comprises a closure member configured to seal the first opening and for the introduction and removal of the sample(s). The apparatus further comprises at least one high pressure pump in fluid communication with the container through the second opening. The high-pressure pump is configured to deliver the pressure medium at high pressure to isostatically compress and compact the sample.

### TECHNICAL FIELD

The present disclosure generally relates to an isostatic pressing apparatus. More specifically, the present disclosure relates to a lab-scale cold isostatic pressing (CIP) apparatus.

### BACKGROUND

Cold isostatic pressing (CIP) is a material processing technique commonly used in industry for compacting powders in a highly pressurized liquid. For a wet bag CIP process, the apparatus generally includes a pressure vessel adapted to hold pressure medium (typically hydraulic oil or water) and an elastomeric container (e.g., latex or polyurethane mold or bag) to hold a powder material that needs to be compacted. The elastomeric container is filled with the powder material and sealed before direct immersion into the pressure medium. For conventional small-scale (lab-scale) CIP, after sealing the pressure vessel, a hydraulic press is used to apply force to a piston which in turn pressurizes the pressure medium. The pressure from the pressure medium compresses the elastomeric container and its content. After releasing the pressure, the vessel is opened, the elastomeric container is removed and the formed compact article is retrieved.

However, in conventional lab-scale apparatus, the pressure is limited by the opening of the pressure vessel (i.e., the diameter of the piston) and size of the hydraulic press. As the diameter of the piston increases, so does the area of the opening. so, for an opening twice as large, 4 times the force is required to reach the same pressure. Further a typical laboratory press can exert up to 25 Ton force. So, for a typical CIP pressure of 275 MPa, the opening (and therefore maximum sample diameter) is limited to around 25 mm/(1 inch). For a 100 T press which is not readily available and also very costly, heavy and large, the maximum opening and sample diameter would be around 50 mm/2 inches to reach the same pressure. Furthermore, the piston of the conventional lab-scale CIP moves during operation as it is pushed down into the chamber, meaning the sealing is “dynamic”, which is known to reduce lifetime of the seal under repeated use. While the conventional apparatus may be suitable for small items, the apparatus is not suitable for producing articles of reasonable dimension over 25 mm without requiring large, heavy and expensive equipment e.g., a large hydraulic press.

Currently there is no known solution available which addresses the issues cited in the background. Below are some examples of published information related to other types of Cold Isostatic Press.

Jin Suk Jang published U.S. Pat. No. 9,718,245, entitled “Combination apparatus of cold isostatic press and general press” discloses a combined cold isostatic press and general press capable of simultaneously performing cold isostatic pressing using pressure of fluid and general pressing using mechanically applied pressure. The combined cold isostatic press and general press include a main frame having a center penetration region. A pressure vessel is located in the penetration region and shaped for performing cold isostatic pressing using fluid injected therein. The main frame supports a top lid and a lower lid to hermetically seal the pressure vessel. A press unit is located between the top lid and the main frame to perform pressing using pressure applied by the top lid as the top lid slides from the pressure vessel.

Donald E. Witkin published U.S. Pat. No. 3,931,382, entitled “method for rapid isostatic pressing” discloses a method for compacting preheated powder bodies in a high pressure isostatic pressure vessel. A preheated workpiece is inserted into the vessel, which is closed and sealed. The vessel is then rapidly filled with the liquid pressurizing medium without said liquid contacting the workpiece. The remainder of the vessel is filled with the liquid pressurizing medium, which raises the pressure of the liquid to a pressure above the critical pressure of the liquid to compact the workpiece or article. However, the current state-of-technology lacks to provide a CIP apparatus that has a configuration suitable for use at laboratory scale and also lacks to address the afore-discussed drawbacks.

Therefore, there is a need for a cold isostatic pressing apparatus that addresses one or more afore-discussed shortcomings.

### SUMMARY

According to the present disclosure, a cold isostatic pressing apparatus is disclosed. The apparatus comprises a container having a container body. The container body comprises a cavity. The cavity could be filled or unfilled with a pressure medium prior to pressurization. The cavity has at least one of cylindrical, ellipsoid, spherical, rectangular, irregular 3D shape, or one or more sections having different shapes. The cavity comprises one or more openings. The openings comprise a first opening and a second opening. The container comprises a base and side walls extending from the base to define the cavity with the first opening. The second opening is configured proximal to the base of the container for pumping in the pressure medium. Also, the second opening could be configured at the closure member.

The cavity is configured to receive one or more samples through the first opening. The sample refers to any material or materials which are for pressing without an elastomeric container and also material or materials including the elastomeric container. The container houses one or more samples to be compressed. The apparatus further comprises a closure member configured to seal the first opening for the introduction of the sample into the cavity. The closure member includes a plurality of first threads configured to lock with a plurality of second threads configured at an interior side of a rim of the container body. In an example, the first threads are male threads and the second threads are female threads. The high-pressure sealing is achieved with commercially available seals. The seal could be a piston seal configuration on the closure member, a rod seals seated in the container body, or a combination of both piston seals and rod seals. A “back-up” seal made of a harder material (such as polyetheretherketone (PEEK)) or metal is also employed to stop extrusion of the seal into the gap behind.

The apparatus further comprises at least one seal disposed at a portion proximal to the rim of the container body to lie between the closure member and the sidewalls of the container body. The apparatus comprises at least one seal disposed over the body of the closure member, or at least one seal disposed at a portion proximal to the rim of the container body and at least one seal disposed over the body of the closure member. The seals are configured to engage to one another on sealing the cavity of the container body with the closure member. The seal is a circular ring member. The sealing is made with gaskets (such as metal gaskets) which are replaced between uses. The present disclosure could use any sealing types, any combination of sealing types and arrangement of the sealing types that would be apparent to one skilled in the art.

The apparatus further comprises at least one high-pressure pump capable of providing the required pressure of the pressure medium. The high-pressure pump is at least one of a hydraulic hand pump, a hydraulic pressure pump, a hydraulic electric pump, a hydraulic pneumatic pump, electric pump or a hydraulic intensifier. The high-pressure pump is in fluid communication with the container through the second opening. The apparatus comprises a fluid line extending between the second opening of the container and the hydraulic pump to fluidly connect the container to the second opening. In an example, the fluid line could be a tubing or a hose. The high-pressure pump could also be directly connected to the container. The high-pressure pump and the container are an integral unit.

The high-pressure pump comprises a reservoir. In an aspect of the present disclosure, the reservoir is at least partially filled with the pressure medium. The high-pressure pump is configured to deliver the pressure medium at a predefined fluid pressure to isostatically compress and compact the sample(s). The pressure medium is at least one of hydraulic fluid and water. In another aspect of the present disclosure, the reservoir is unfilled with the pressure medium. The high-pressure pump is configured deliver the pressure medium to the cavity form an external source. The apparatus further comprises a third opening configured at a portion of the sidewall proximal to the second threads. The third opening is configured to enable free movement of air during sealing and opening the cavity. The third opening could be configured on at least one of the high pressure and low-pressure side of the seal. When the third opening is configured on the low-pressure side of the seal, additional valve is configured on the apparatus 100. The additional valve could be configured to open and close either by automatically or manually. The additional value is closed prior to pressurization and could be opened after depressurization when removing the sample(s) to allow air to move more freely and facilitate opening and closing.

During operation, the sample(s) is (are) introduced within the cavity of the container. Then, the closure member is advanced into the first opening until the closure member rests over the rim of the container body. Further, the first threads of the closure member are screwed over the second threads configured at the first opening, which locks the closure member to the container body and seals the cavity.

After sealing the cavity, the high-pressure pump is activated to admit the hydraulic fluid at a predefined pressure required to mold or compact the sample(s). As the container reaches the desired pressure, the sample(s) is isostatically compressed which compacts the sample(s) to form article(s). After the container has reached the desired pressure to compress the sample(s), the pressure is released. Further, the sample(s) are removed from the container.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative aspects can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Aspects incorporating teachings of the present disclosure are shown and described with respect to the figures presented herein, in which:

FIG. 1 exemplarily illustrates a perspective view of a cold isostatic pressing apparatus.

FIG. 2 exemplarily illustrates a cross-section of a container receiving a closure member of the apparatus of FIG. 1.

FIG. 3 exemplarily illustrates a perspective of the container.

FIG. 4 exemplarily illustrates a perspective view of the closure member.

FIG. 5 exemplarily illustrates a perspective view of the closure member having a seal.

### DETAILED DESCRIPTION OF EXAMPLE ASPECTS

A description of aspects of the present disclosure will now be given with reference to the Figures. It is expected that the present disclosure may be embodied in other specific forms without departing from its spirit or essential characteristics. The described aspects are to be considered in all respects only as illustrative and not restrictive.

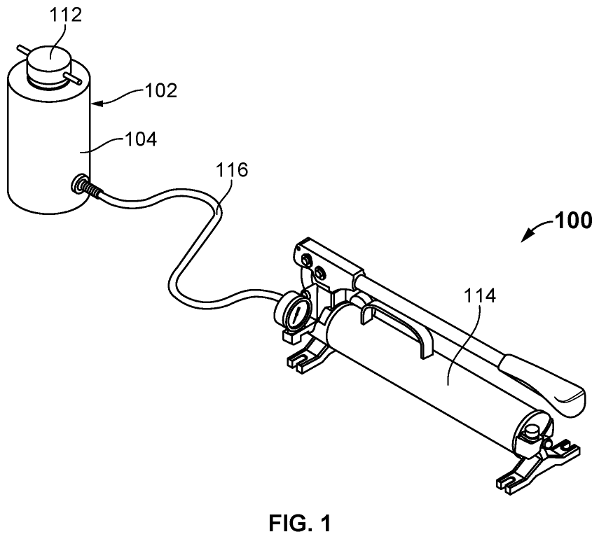

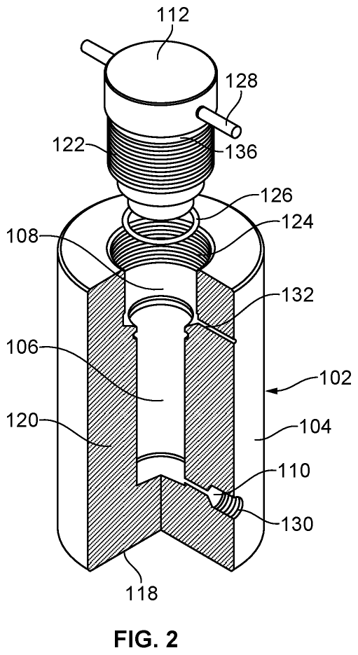

FIG. 1 exemplarily illustrates a perspective view of a cold isostatic pressing (CIP) apparatus 100, according to an aspect of the present disclosure. The apparatus 100 comprises a container 102 having a container body 104. The container body 104 comprises a cavity 106 (shown in FIG. 2) configured to receive a pressure medium. The cavity 106 is at least partially filled with the pressure medium before pressurization of the container 102, or the cavity 106 is unfilled with the pressure medium before pressurization of the container 102. Referring to FIG. 2, the container body 102 further comprises one or more openings. The openings comprise a first opening 108 and a second opening 110. The first opening 108 is configured to provide access to the cavity 106. The first opening 108 is configured for the introduction of at least one sample into the cavity 106. The sample comprises an elastomeric container. The elastomeric container comprises the items to be compacted, and is sealed.

Often, the item/s to be compacted is placed in an elastomeric container (e.g., latex or polyurethane mold or bag) to hold or shape the item during compaction and prevent contact between the oil and the sample. When an elastomeric container is used, the elastomeric container is filled with the powder material and sealed before direct immersion into the pressure medium. When the elastomeric container is not used, the sample is added directly to the pressure medium. Henceforth, the term “sample” refers to any material or materials which are for pressing, including elastomeric container or not, “item” refers any powder or compacts which are placed into elastomeric container and “article” refers to the sample after least one pressurization cycle.

The sample(s) could be a pre-pressed sample(s) (for example, by uniaxial pressing), which needs subsequent isostatic pressing. The sample(s) could be a pre-pressed ceramic, (known as a green body) or a powder material. The sample could include an elastomeric mold. During operation, multiple molds or elastomeric bags can be introduced into the chamber at the same time. The sample(s) is placed in a mold comprised of both elastomeric and hard materials which can limit displacement in certain directions e.g., a mold with rubber sides but fixed metal cap at the top and bottom will have greater displacements next to the rubber sides than the top and bottom and a mold with metal sides and rubber at the top and bottom will experience greater displacement at the top and bottom compared to the sides (which more closely resembles uniaxial pressing). Further, the sample could be placed directly into the pressure medium without use of an elastomeric container e.g., for a sample which is already sealed from oil penetration or where the goal is to impregnate oil into the sample.

The apparatus 100 further comprises a closure member 112 configured to seal the cavity 106. The apparatus 100 further comprises at least one high pressure pump 114 in fluid communication with the container 102. The high-pressure pump is at least one of a hydraulic hand pump, a hydraulic electric pump, a hydraulic pneumatic pump, an electric pump, a hydraulic pump and a hydraulic intensifier. The apparatus 100 further comprises a fluid line 116 extending between the second opening 110 of the container 102 and the high-pressure pump 114 to fluidly connect the high pressure pump 114 and the container 102. The high pressure pump 114 could be directly connected to the cavity 106 of the container. The high pressure pump 114 and the container 102 is an integral unit.

The high pressure pump 114 further comprises at least one reservoir configured to receive the pressure medium. The reservoir is at least partially filled with the pressure medium or unfilled with the pressure medium. The high-pressure pump 114 is configured to deliver the pressure medium to the chamber and increase the pressure, isostatically compress and compact the sample(s). The high-pressure pump 114 is configured to deliver the pressure medium to the cavity 106 from an external source. The pressure medium is at least one of hydraulic fluid and water.

Referring to FIG. 2, the container body 104 comprises a base 118 and a plurality of side walls 120 extending from the base 118 configured to define the cavity 106 with the first opening 108. In an aspect of the present disclosure, the cavity 106 is fully filled with the pressure medium. In another aspect of the present disclosure, the cavity 106 is partially filled with the pressure medium. According to yet another aspect, the cavity 106 contains no pressure medium which is introduced during pressurization prior to pressurization. The partially filled cavity 106 may contain some air. The air is compressed in the cavity 106 during pressurization.

The container body 104 comprises the first opening 108 and the second opening 110. The first opening 108 and the second opening 110 may have any diameter. The first opening 108 is provided at a top portion of the container 102. The first opening 108 is configured to provide access to the cavity 106. The first opening 108 is configured for the introduction of the sample(s) into the cavity 106. The cavity 106 is filled with the pressure medium via the first opening 108. The apparatus 100 comprises a plurality of second threads 124. The second threads 124 are configured at an interior side of a rim of the container body. In an example, the second threads 124 are female threads.

The second opening 110 is provided proximal to the base 118. Alternatively, the second opening 110 could be configured at the closure member 112. The second opening 110 establishes a fluid communication between the container 102 and the high-pressure pump 114 via the fluid line 116. The fluid line 116 could be a hose. The apparatus 100 comprises a solid connection to directly adjoin the high pressure pump 114 to the container 102. The second opening 110 is configured for the introduction of the pressure medium at a predefined fluid pressure from the reservoir of the high-pressure pump 114 to the cavity 106 of the container 102. The second opening 110 comprises a plurality of third threads 130 to fasten with the fluid line 116. The third threads 130 are used to securely lock fluid line 116 to the second opening 110 of the container 102.

The container 102 is sealed using the closure member 112. The closure member 112 is removably screwed to the first opening 108 of container 102 to seal the cavity 106. The closure member 112 comprises a fastening assembly configured to removably lock with the container 102 to close and open the first opening 108. The closure member 112 has a body 136 complementary to the first opening 108 of the container 102 to snugly fit at the first opening 108. The body 136 has a plurality of first threads 122 at an exterior surface of the body. In an example, the first threads 122 are male threads. The first threads 122 are configured to lock with the second threads 124 of the container 102 to seal the cavity 106. The first threads 122 are configured at an exterior surface of the container body 104 and the second threads 124 are configured at an interior surface of the closure member 112, which enables the closure member 112 to lock over the container body 104. The apparatus 100 further comprises a quick connect coupling assembly for sealing the cavity 106 of the container 102.

The closure member 112 further comprises at least one seal 126 disposed at a portion proximal to a rim of the container body 104 to lie between the closure member 112 and the sidewalls 120 of the container body 104. The seal 126 is a circular ring member. The seal 126 could be made of metal. The seal 126 could be made of any other suitable material. The sealing is made with gaskets (such as metal gaskets) which are replaced between uses. The present disclosure could use any sealing types, any combination of sealing types and arrangement of the sealing types that would be apparent to one skilled in the art. The closure member 112 further comprises a handle 128 extending at both sides from an upper end of the closure member 112 for easy handling of the closure member 112.

Optionally, the container body 104 comprises a third opening 132. The third opening 132 is configured at a portion of sidewall 120 proximal to the second threads 124. The third opening 132 is configured to enable free movement of air during sealing and opening the cavity 106. The apparatus 100 comprises the third opening 132 below the second threads 124 and an additional valve to open and/or close the third opening 132. The valve facilitates to open the third opening 132 during opening or closing the cavity 106. The valve facilitates to close the third opening 132 while pressuring the cavity 106. The third opening 132 is configured above the second threads 124. If the third opening 132 is configured above the second threads 124, the closure member 112 could open and/or close the third opening 132, and a separate valve is not required but may be included to prevent leaks after seal failure.

Further, the third opening 132 could be configured on at least one of the low-pressure side or high pressure side of the seal 126. If the third opening 132 is configured on the low pressure side of the seal 126, an additional valve is configured on the apparatus 100. The additional valve could be configured to open and close either by automatically or manually. The additional valve is closed prior to pressurization and could be opened after depressurization when removing the sample(s) to allow free movement of air.

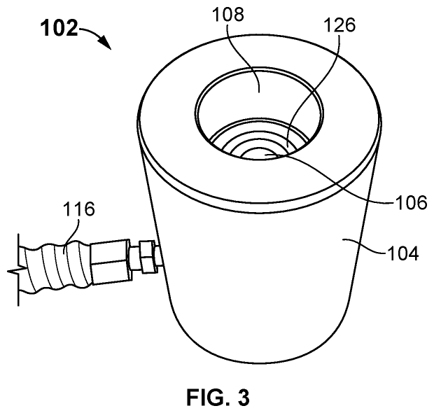

Referring to FIG. 3, the container body 104 and the cavity 106 has a cylindrical shape. The container body 104 and cavity 106 could have any other suitable shapes. Further, the container body 104 could be any other mechanical enclosure. Further, the cavity 106 could have at least one of ellipsoid, spherical, rectangular, and irregular 3D shape. The cavity 106 could be made of one or more sections with different shapes, and rounded and flat sides. The cavity 106 has a base, a middle portion extending from the base and a top portion. The top portion and the base portion have at least one of flat and semi spherical configuration, and the middle portion has a cylindrical configuration. The cavity 106 comprises the first opening 108 to receive the sample(s) therethrough. The fluid line 116 is attached to the container 102 via the second opening 110 configured to provide the fluid communication between the container 102 and the high-pressure pump 114.

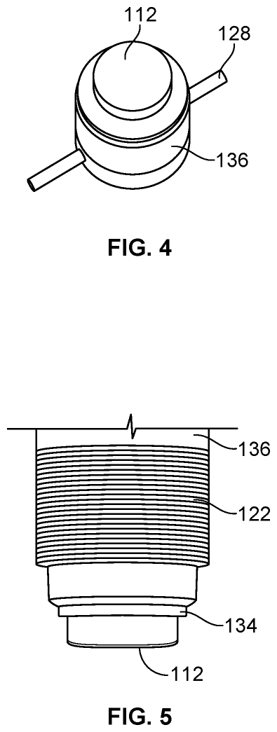

Referring to FIG. 4, the closure member 112 is configured to removably lock to the container 102 to close and open the cavity 106. The closure member 112 provides static sealing. The closure member 112 has a cylindrical screw body. The closure member 112 further comprises a handle 128 extending at both sides from an upper end of the closure member 112.

Referring to FIG. 3 and FIG. 5, the apparatus 100 comprises at least two seals (126, 134). The seal 126 is disposed a portion proximal to the rim of the container body 104 and the seal 134 is disposed over the body 136 of the closure member 112. The seals (126, 124) are configured to engage to one another on sealing the cavity 106 of the container body 104 with the closure member 112. The seals (126, 134) are a circular ring member. The seal (126, 134 could be made of metal. The seal (126, 134) could be made of any other suitable material.

The high-pressure sealing is achieved with commercially available seals. The seal could be a piston seal configured on the closure member, a rod seals seated in the container body 104, or a combination of both piston seal and the rod seal. Further, a back-up seal made of a hard material (such as polyetheretherketone (PEEK)) or metal is also employed to stop extrusion of the seal into the gap behind.

In an aspect of the present disclosure, a method of high-pressure treatment of at least one sample by the apparatus 100 is disclosed. Initially, at least sample is introduced within the cavity 106 of the container 102. Then, the closure member 112 is advanced into the first opening 108 until the closure member 112 rests over the rim of the container body 104. Further, the first threads 122 of the closure member 112 is screwed over the second threads 124 at the first opening 108, which locks the closure member 112 to the container body 104 and seals the cavity 106.

After sealing the cavity 106, the high-pressure pump 114 is activated to admit the hydraulic fluid at a pressure required to mold or compact the sample(s). As the cavity 106 reaches the desired pressure, the sample(s) is isostatically compressed and compacts the sample(s).

After the container 102 has reached the desired pressure to compress the sample(s), and the desired hold time at pressure which may typically last from seconds to several minutes, the pressure is released. The apparatus 100 could be operated manually by an operator by manipulation of suitable valves to relieve the pressure and return the pressure medium to the reservoir. The apparatus could be adapted for automatic operation in which the elements are controlled either by push button control or running a predefined program or pressurization and depressurization.

The apparatus 100 is a laboratory scale device. In an example, the apparatus 100 weighs about 26 kg. The apparatus 100 is suited for treatment of research-based materials and smaller samples but can be enlarged for treatment of larger samples. The container 102 is a pressure vessel. The container 102 and cavity 106 could be made in any desired size. In an example, the apparatus 100 could have a container 102 diameter of 300 mm, and inner diameter of 150 mm and chamber inner height of 600 mm. Further, the apparatus 100 having larger cavity 106, larger pumps such as electric pump with a large reservoir are used. The container 102 is made from high strength steels such as 4140 steel, 4340 steel, high-strength stainless steel, or other equivalent materials. The steel is typically heat treated for increased strength and toughness.

Advantageously, the apparatus of the present disclosure is designed to use in laboratory scale. The apparatus provides a high-pressure cold isostatic press for making long aspect ratio pellets and odd shapes defined by the user. Prefabricated molds could be used to make the required shapes of the sample. The apparatus could be used in any powder compaction application such as polymer processing, metal processing, and powder metallurgy and ceramic processing for example for pre-densifying ceramics before sintering. The unit may also be used for testing of materials under high pressure or extreme environments such as deep sea. The apparatus utilizes the high-pressure pump to deliver the pressure, which eliminates the need of separate large press for compressing the sample.

According to the present disclosure, in an example, for a 38 mm inner diameter of the container 102, the associated high pressure pump 114 weighs about 26 Kg. In conventional apparatus, a 38 mm ID piston-based CIP would weigh about 70-100+ kg including a 40 ton press to enable to reach the desired pressure to compact the sample. The piston-based CIP must be designed within the confines of the pressing window of the press setting a maximum height also. However, the present disclosure provides a compact and lighter weight apparatus 100 with greater flexibility to meet user requirements. Further, the apparatus 100 does not require an additional hydraulic press, and the maximum pressure of the container 102 is not defined by the piston size (opening diameter), which gives the user more freedom in terms of sample sizes that can be used. The static sealing of container 102 is also a preferable alternative to the dynamic sealing of piston-based CIPs, which wear quicker and require more maintenance and replacement. Further, the apparatus 100 is inexpensive to manufacture and economical.

While the disclosure has been described with reference to exemplary aspects, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular aspects disclosed for carrying out this disclosure, but that the disclosure will include all aspects falling within the scope of the appended claims. Moreover, the use of the terms first, second, etc. do not denote any order or importance, but rather the terms first, second, etc. are used to distinguish one element from another.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described aspects were chosen and described in order to best explain the principles of the disclosure and the practical application, and to enable others of ordinary skill in the art to understand the disclosure for various aspects with various modifications as are suited to the particular use contemplated.

What is claimed is:

1. A cold isostatic pressing apparatus, comprising:
a container comprising a container body, wherein the container body comprising a cavity configured to receive a pressure medium, wherein the cavity comprises at least one opening including a first opening, wherein the cavity is configured to receive at least one sample through the first opening;
a closure member configured to seal the first opening for the introduction of the sample, and
at least one high pressure pump in fluid communication with the container through a second opening, wherein the high pressure pump comprises a reservoir, wherein the high pressure pump is configured to deliver the pressure medium, and pressurize the pressure medium to isostatically compress and compact the sample.

2. The apparatus of claim 1, wherein the cavity is at least partially filled with the pressure medium before pressurization of the container.

3. The apparatus of claim 1, wherein the cavity is unfilled with the pressure medium before pressurization of the container.

4. The apparatus of claim 1, wherein the reservoir is at least partially filled with the pressure medium and the high pressure pump is configured to deliver the pressure medium to the cavity from the reservoir.

5. The apparatus of claim 1, wherein the high pressure pump is configured to deliver the pressure medium to the cavity form an external source.

6. The apparatus of claim 1, further comprises a fluid line extending between the second opening of the container and the high pressure pump.

7. The apparatus of claim 1, wherein the high pressure pump and the container is an integral unit.

8. The apparatus of claim 1, wherein the cavity has at least one of cylindrical, ellipsoid, spherical, rectangular, irregular 3D shape, or one or more sections having different shapes.

9. The apparatus of claim 1, wherein the pressure medium comprises at least one of hydraulic fluid and water.

10. The apparatus of claim 1, wherein the high pressure pump is at least one of a hydraulic pressure pump, a hydraulic hand pump, a hydraulic electric pump, a hydraulic pneumatic pump, an electric pump and a hydraulic intensifier.

11. The apparatus of claim 1, wherein the closure member comprises a body complementary to the first opening of the container and a plurality of first threads.

12. The apparatus of claim 1, wherein the container body comprises a base, a plurality of sidewalls extending from the base to define the cavity with the first opening and a plurality of second threads, wherein the first threads of the closure member are configured to lock with the second threads on the container.

13. The apparatus of claim 1, wherein the second opening is configured at the container.

14. The apparatus of claim 1, wherein the second opening is configured at the closure member.

15. The apparatus of claim 1, further comprises a combination of at least one of a piston seal and a rod seal.

16. The apparatus of claim 15, wherein the piston seal is configured at the closure member.

17. The apparatus of claim 15, wherein the rod seal is configured at the container body.

18. The apparatus of claim 1, further comprises at least one seal disposed at a portion proximal to a rim of the container body to lie between the closure member and the sidewalls of the container body, wherein the seal is a circular ring member.

19. The apparatus of claim 1, further comprises at least one seal disposed at a portion proximal to the rim of the container and at least one seal disposed over the body of the closure member, wherein the seals are configured to engage to one another on sealing the cavity of the container body with the closure member, wherein the seal is a circular ring member.

20. The apparatus of claim 1, further comprises a third opening configured at a portion of the sidewall proximal to the second threads, and a valve to open and close the third opening, wherein the third opening is configured to enable free movement of air during sealing and opening the cavity.
